(19) United States
(12) Patent Application Publication
(10) Pub. No.: US 2020/0227771 A1
(43) Pub. Date: Jul. 16, 2020

(54) FUEL CELL MODULE

(71) Applicant: TOYOTA JIDOSHA KABUSHIKI KAISHA, Toyota-shi (JP)

(72) Inventors: Masahiko MORINAGA, Toyota-shi (JP); Masahiro KATAYAMA, Seto-shi (JP)

(21) Appl. No.: 16/828,353

(22) Filed: Mar. 24, 2020

Related U.S. Application Data
(63) Continuation of application No. 15/678,882, filed on Aug. 16, 2017.

(30) Foreign Application Priority Data
Sep. 16, 2016 (JP) 2016-181607

(51) Int. Cl. H01M 8/2432; H01M 8/04007; H01M 8/04089

(52) U.S. Cl. CPC H01M 8/2432; H01M 8/04067; H01M 2008/1095; H01M 8/04007; H01M 8/04089

(57) ABSTRACT

There is provided a fuel cell module comprising a fuel cell, a fuel cell auxiliary machine, and a module case configured to place the fuel cell and the fuel cell auxiliary machine therein. The module case comprises a first space in which the fuel cell is placed and a second space in which the fuel cell auxiliary machine is placed. The first space and the second space adjoin to each other via a partition plate. The partition plate includes a communicating hole that connects the first space and the second space and that is formed in an opening shape having a side or a diameter that is smaller than a width of a gap between the fuel cell and the partition plate.

### CROSS-REFERENCE TO RELATED APPLICATIONS

The present application is a continuation of U.S. application Ser. No. 15/678,882, filed Aug. 16, 2017, which claims priority from Japanese patent application 2016-181607 filed on Sep. 16, 2016, the entirety of the content of which is hereby incorporated by reference into this application.

### BACKGROUND

### Field

The present disclosure relates to a fuel cell module.

### Related Art

A fuel cell may be placed in a fuel cell case and mounted on, for example, a vehicle. JP 2011-204500A discloses a configuration that an auxiliary machine chamber in which a fuel cell auxiliary machine is placed is provided to adjoin to a fuel cell.

Hydrogen, a hydrocarbon, au alcohol or the like is generally used as a fuel of the fuel cell. Hydrogen has a small lower limit of a combustion range (expressed as percent by volume, vol %, of an ignitable combustible gas in a gaseous mixture of the combustible gas and the air). When hydrogen is used as the fuel of the fuel cell, the security is an important issue. There is accordingly a demand for improving the safety of a fuel cell module including a case provided to place a fuel cell and a fuel cell auxiliary machine therein.

In order to address at least part of the problem described above, the disclosure may be implemented by aspects or configurations described below.

### SUMMARY

According to one aspect of the disclosure, there is provided a fuel cell module. The fuel cell module has: a fuel cell; a fuel cell auxiliary machine; and a module case configured to place the fuel cell and the fuel cell auxiliary machine therein. The module case has a partition plate, a first space in which the fuel cell is placed and a second space in which the fuel cell auxiliary machine is placed. The first space and the second space adjoin to each other via the partition plate. The partition plate has a communicating hole that connects the first space and the second space and that is formed in an opening shape having a side or a diameter that is smaller than a width of a gap between the fuel cell and the partition plate.

### BRIEF DESCRIPTION OF DRAWINGS

FIG. 1 is a diagram illustrating the schematic configuration of a fuel cell module according to a first embodiment of the disclosure;

FIG. 2 is a schematic plane view illustrating an upper plate;

FIG. 3 is a diagram illustrating the flow of a combustion wave;

FIG. 4 is a schematic plan view illustrating a first heat conductor and a second heat conductor included in a fuel cell module according to a second embodiment;

FIG. 5 is an enlarged sectional view illustrating the periphery of first communicating holes according to the second embodiment;

FIG. 6 is an enlarged sectional view illustrating the periphery of first communicating holes according to a third embodiment;

FIG. 7 is an enlarged sectional view illustrating the periphery of first communicating holes according to a fourth embodiment;

FIG. 8 is schematic plan view illustrating an upper plate of a fuel cell module according to a fifth embodiment;

FIG. 9 is a schematic plan view illustrating an upper plate of a fuel cell module according to a sixth embodiment;

FIG. 10 is a schematic plan view illustrating an upper plate of a fuel cell module according to a seventh embodiment;

FIG. 11 is a diagram illustrating the schematic configuration of a fuel cell module according to an eighth embodiment; and

FIG. 12 is a schematic front view illustrating a first side plate.

### DESCRIPTION OF EMBODIMENTS

### A. First Embodiment

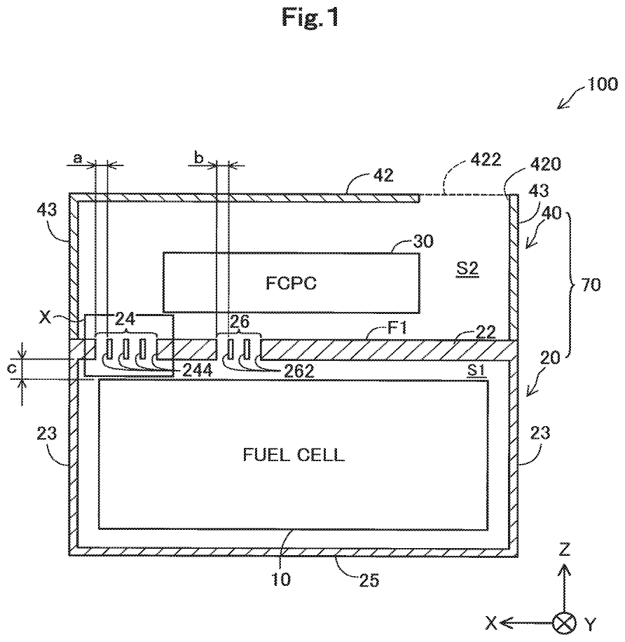

FIG. 1 is a diagram illustrating the schematic configuration of a fuel cell module 100 according to a first embodiment of the disclosure. FIG. 1 illustrates a schematic section by an XZ plane of the fuel cell module 100, along with XYZ axes that are orthogonal to one another. In the description hereof, a Z-axis direction shown in FIG. 1 is defined as “vertical direction”. A+(plus) Z axis side is also called “upper side”, and a −(minus) Z axis side is also called “lower side”. The fuel cell module 100 includes a fuel cell 10 an FC power control unit (hereinafter called “FCPC”) 30 and a module case 70. The fuel cell 10 and the FCPC 30 are fastened to the module case 70. Illustration of fixtures is omitted in FIG. 1, in order to facilitate technical understanding.

The fuel cell 10 is a polymer electrolyte fuel cell configured to obtain an electromotive force by an electrochemical reaction of hydrogen serving as a fuel gas with oxygen in the air serving as an oxidizing gas. The fuel cell 10 has a stacked structure by stacking a plurality of unit cells (not shown) in a plate-like shape in an X-axis direction. In the description below, the X-axis direction is also called “stacking direction”. As described later in detail, the fuel cell 10 includes a first cell stack and a second cell stack, which are both stacked bodies by stacking a plurality of unit cells (not shown). The first cell stack and the second cell stack are arrayed in a Y-axis direction (direction perpendicular to the stacking direction). A compressive load is applied to the fuel cell 10 in the stacking direction of the unit cells (X-axis direction), so that the stacking state of the plurality of unit cells is maintained in the fuel cell 10. The fuel cell 10 is not limited to the polymer electrolyte fuel cell, but any of various other types of fuel cells using hydrogen as the fuel gas may be employed.

The FCPC 30 is one of auxiliary machines for fuel cell and is configured by integrating an FC converter with a pump inverter. The FC converter is a DC-DC converter configured to boost the output voltage of the fuel cell 10 to a high voltage adequate for driving a drive motor (not shown) and is connected with an output terminal of the fuel cell 10. The pump inverter is connected with a secondary battery (not shown) and is configured to convert a DC power from the secondary battery into an AC power and supply the AC power to a hydrogen pump (not shown) and a water pump (not shown), such as to drive these pumps.

The module case 70 is provided as a case configured to place the fuel cell 10 and the FCPC 30 therein and includes a fuel cell case 20 and an FCPC case 40 that is placed above the fuel cell case 20 and is fixed to the fuel cell case 20. According to this embodiment, the module case 70 is made of an aluminum (Al) alloy. The material used to form the fuel cell case 20 is, however, not limited to aluminum but may be another metal material, such as steel or stainless steel.

The FCPC case 40 is provided as a bottom-open housing that includes an upper plate 42 and four side plates 43. A through hole 420 having a rectangular opening shape and a hydrogen permeable membrane 422 arranged to close the through hole 420 are provided on a minus X-axis side end of the upper plate 42. The hydrogen permeable membrane 422 is made of a material that allows for permeation of hydrogen while preventing dust and dirt from passing through. Part of hydrogen present in the FCPC case 40 is released through the hydrogen permeable membrane 422 out of the fuel cell module 100. The FCPC case 40 is placed on the fuel cell case 20 with its opening facing down and is fixed to the fuel cell case 20. This provides a second space S2 to place the FCPC 30 therein.

According to this embodiment, the FCPC 30 is placed away from the upper plate 42 of the FCPC case 40 across a gap and is fixed to the upper plate 42 by means of a support member (not shown). The FCPC 30 is placed and fastened in the FCPC case 40 and the FCPC case 40 is fixed on the fuel cell case 20, so that a gap is formed between the FCPC 30 and the fuel cell case 20.

The fuel cell case 20 is provided as a rectangular parallelepiped housing that includes an upper plate 22, four side plates 23 and a lower plate 25 and forms a first space Si to place the fuel cell 10 therein. The fuel cell 10 is fixed to the fuel cell case 20 by means of a support member (not shown). A gap of a width c is formed between the upper plate 22 of the fuel cell case 20 and the fuel cell 10, and a gap is also formed between the lower plate 25 of the fuel cell case 20 and the fuel cell 10. For example, when the fuel cell module 100 is mounted on a vehicle, the width c of the gap between the fuel cell 10 and the upper plate 22 is determined such that the fuel cell 10 does not hit against the upper plate 22 by vibration during driving of the vehicle and that the fuel cell 10 is not broken even in the case of a collision of the vehicle.

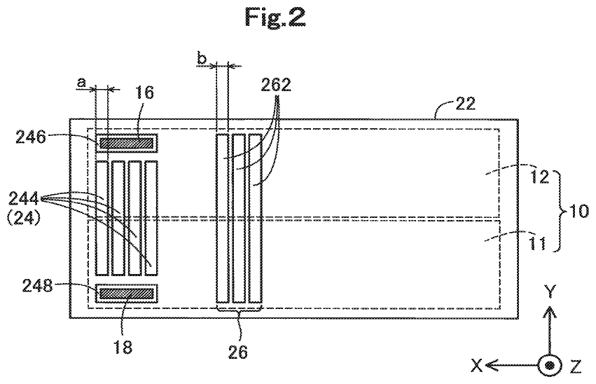

FIG. 2 is a schematic plat view illustrating the upper plate 22 of the fuel cell case 20. The schematic plan view of FIG. 2 illustrates the upper plate 22 viewed from the second, space S2-side (shown in FIG. 1). The location of the fuel cell 10 is shown by broken lines in FIG. 2. The upper plate 22 has a first hole portion 24 including four first communicating holes 244, a second hole portion 26 including three second communicating holes 262, a first terminal communicating hole 246 and a second terminal communicating hole 248. As shown in FIG. 1, the first space S1 in which the fuel cell 10 is placed and the second space S2 in which the FCPC 30 is placed are arranged to adjoin to each other via the upper plate 22 in the module case 70. The plurality of communicating holes 244 and 262 provided in the upper plate 22 cause the first space S1 and the second space S2 to communicate with each other. The gas present in the first space S1 and the gas present in the second space S2 mutually move in and out through the plurality of such communicating holes. The upper plate 22 according to this embodiment is also called “partition plate”.

The first terminal communicating hole 246 has a rectangular opening shape. The first terminal communicating hole 246 is formed at a position corresponding to a first output terminal 16 of the fuel cell 10. The second terminal communicating hole 248 has a similar opening shape to that of the first terminal communicating hole 246 and is formed at a position corresponding to a second terminal 18 of the fuel cell 10. As described above, the fuel cell 10 includes a first cell stack 11 and a second cell stack 12 that has a similar configuration to that of the first cell stack 11 and is arranged in parallel to the first cell stack 11 (as shown in FIG. 2). The first cell stack 11 and the second cell stack 12 are arranged such that the respective unit cells are stacked to provide mutually opposite polarities and that respective minus X-axis side ends of the cell stacks 11 and 12 are electrically connected with each other. The two cell stacks 11 and 12 accordingly constitute one unit cell series connector to provide a desired high voltage. The first output terminal 16 and the second output terminal 18 of the fuel cell 10 are located on a plus X-axis side end (in other words, an end in the stacking direction) in the fuel cell 10. The first output terminal 16 and the second output terminal 18 are shown as hatched areas with slant lines in FIG. 2, in order to clearly distinguish from the first terminal communicating hole 246 and the second terminal communicating hole 248. End plates, current collectors, insulating plates and the like included in the fuel cell 10 are omitted from the illustration of FIG. 2.

The first output terminal 16 of the fuel cell 10 is placed to pass through the first terminal communicating hole 246, and the second output terminal 18 of the fuel cell 10 is placed to pass through the second terminal communicating hole 248. The FCPC 30 and the fuel cell 10 are connected with each other by means of a cable in the second space S2 formed in the FCPC case 40.

The first hole portion 24 is located between the first terminal communicating hole 246 and the second terminal communicating hole 248 in the upper plate 22. The first communicating holes 244 are slits (in a rectangular opening shape in which its short side is extremely shorter than its long side) (as shown in FIG. 2) and has a length a of its short side shorter than the width c of the gap between the fuel cell 10 and the upper plate 22 (shown in FIG. 1). In the description hereof, the width of a gap between the fuel cell and the partition plate (upper plate 22 according to this embodiment) denotes a dimension of the gap in a direction perpendicular to the partition plate at a narrowest position of the gap between the fuel cell and the partition plate. The four first communicating holes 244 are arrayed in the stacking direction of the fuel cell 10 (X-axis direction) such that the long sides of the respective first communicating holes 244 adjoin to each other.

The second hole portion 26 is located on a rear side (minus X-axis direction side) of the first hole portion 24 in the stacking direction of the fuel cell 10 in the upper plate 22. The second communicating holes 262 are also slits (as shown in FIG. 2) and have a length b of its short side shorter than the width c of the gap between the fuel cell 10 and the upper plate 22 (shown in FIG. 1). The three second communicating holes 262 are arrayed in the stacking direction of the fuel cell (X-axis direction) such that the long sides of the respective second communicating holes 262 adjoin to each other. According to this embodiment, the length a of the short side of the first communicating hole 244 is equal to the length b of the short side of the second communicating hole 262 (a=b). According to this embodiment, the lengths a and b of the respective short sides are approximately 0.5 to 1.5 mm, and the width c of the gap between the fuel cell 10 and the upper plate 22 is approximately 2.0 to 3.0 mm.

In assembly of the fuel cell module 100, for example, the FCPC case 40 in which the FCPC 30 is placed is fixed on the upper plate 22 of the fuel cell case 20 in which the fuel cell 10 is placed, by means of, for example, screwing. In this state, the FCPC 30 and the fuel cell 10 are connected with each other via a cable.

As described above, hydrogen as the fuel gas is supplied, to the fuel cell 10. When hydrogen is leaked from a connection between a hydrogen supply piping and the fuel cell 10 or from the fuel cell 10, part of the leaked hydrogen flows mainly through the first hole portion 24 and the second hole portion 26 into the second space S2. The FCPC case 40 has the hydrogen permeable membrane 422, so that at least part of hydrogen in the second space S2 is released out of the fuel cell module 100. More specifically, the fuel cell module 100 of this embodiment includes the first hole portion 24 and the second hole portion 26. Even when hydrogen is leaked from, for example, the fuel cell 10, this configuration prevents the hydrogen concentration in the first space S1 from being increased by the leaked hydrogen.

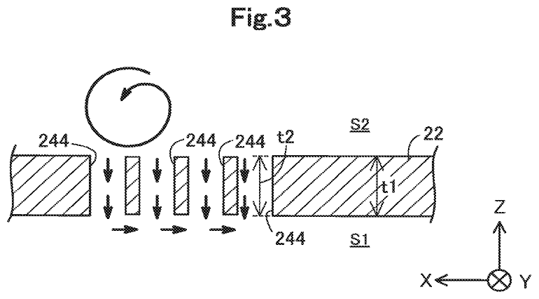

FIG. 3 is a diagram illustrating the flow of a combustion wave. FIG. 3 illustrates enlargement of a portion X in FIG. 1, and an arrow indicates a combustion wave. The FCPC 30 includes, for example, a reactor, a diode, a switch and a smoothing capacitor and has an outer shape with irregularity on the whole (the shape of the FCPC is simplified as a rectangular shape in FIG. 1). Even in the case of ignition that generates a combustion wave in the second space S2, this configuration causes a turbulence to provide turbulent combustion and is likely to increase the combustion rate (rate of flame propagation).

In the fuel cell module 100 of this embodiment, the upper plate 22 (partition plate) of the fuel cell case 20 of the module case 70 includes the first communicating holes 244 and the second communicating holes 262. This configuration causes the combustion wave that includes the turbulence and that is generated in the second space S2 to be subjected to heat removal and to be rectified by the inner wall surfaces of the first communicating holes 244 and the second communicating holes 262 when passing through the first communicating holes 244 and the second communicating holes 262 and then to enter the first space S1. As a result, this configuration decreases the combustion rate (i.e., weakens the combustion wave) or quenches the combustion wave stops combustion).

When the combustion wave in a non-rectified state enters the first space S1, the combustion wave is likely to be mixed with oxygen present in the first space S1 and thereby cause explosive combustion. The configuration of this embodiment, however, causes the rectified combustion wave to enter the first space Si and accordingly reduces such a likelihood.

A depth t2 of the first communicating holes 244 according to this embodiment is equal to a plate thickness ti of the upper plate 22. A depth of the second communicating holes 262 is also equal to the plate thickness ti of the upper plate 22 (as shown in FIG. 1).

According to this embodiment, the length a of the short side of the first communicating holes 244 and the length b of the short side of the second communicating holes 262 are shorter than the width c of the gap between the fuel cell 10 and the upper plate 22. The combustion wave is rectified to have the decreased combustion rate when passing through the first communicating holes 244 and the second communicating holes 262, and then enters the gap between the fuel cell 10 and the upper plate 22 with practically maintaining this state. As a result, this configuration suppresses an increase in combustion rate of the combustion wave that flows into the gap. For example, a configuration that, the length a of the short side of the first communicating holes 244 and the length b of the short side of the second communicating holes 262 are longer than the width c of the gap between the fuel cell 10 and the upper plate 22 is, on the other hand, expected to provide the following situation. The combustion wave that has passed through the individual first communicating holes 244 and second communicating holes 262 further increases its pressure when the combustion wave enters the gap between the fuel cell 10 and the upper plate 22. This increases the reaction rate to increase the heat generation rate and increases the combustion rate. In the fuel cell module 100 of this embodiment, the upper plate 22 of the module case 70 includes the first communicating holes 244 and the second communicating holes 262, and the lengths a and b of the respective short sides of these communicating holes 244 and 262 are shorter than the width c of the gap between the fuel cell 10 and the upper plate 22. Even in the case of ignition of the leaked hydrogen in the FCPC case 40 (second space S2), the configuration of this embodiment suppresses an increase in combustion rate when the combustion wave enters the gap between the fuel cell IC) and the upper plate 22. As a result, this configuration suppresses a pressure increase accompanied with combustion, suppresses the fuel cell case 20 from being broken, and improves the safety of the fuel cell module 100.

### B. Second Embodiment

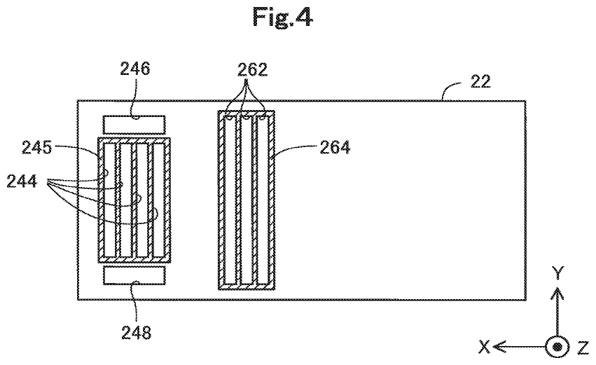

FIG. 4 is a schematic plan view illustrating a first heat conductor 245 and a second heat conductor 264 included in a fuel cell module according to a second embodiment. The configuration of the fuel cell module of the second embodiment is similar to the configuration of the fuel cell module 100 of the first embodiment except the first, heat conductor 245 and the second heat conductor 264. The following thus mainly describes the first heat conductor 245 and the second heat conductor 264. The like components to those of the fuel cell module 100 of the first, embodiment are expressed by the like reference signs, and their description is omitted.

In the fuel cell module of the second embodiment, the first heat conductor 245 is provided on the respective inner walls of the four first communicating holes 244 in the upper plate 22 and peripheries of opening ends of the respective communicating holes 244 (upper face F1 and lower face F2 of the upper plate 22). Similarly the second heat conductor 264 is provided on the respective inner walls of the three second communicating holes 262 and peripheries of opening ends of the respective communicating holes 262 (upper face F1 and lower face F2 of the upper plate 22).

The opening area of the first communicating hole 244 defined by the first heat conductor 245 is equal to the opening area of the first communicating hole 244 according to the first embodiment. Accordingly, the area of the inner wall of the first communicating hole 244 according to the second embodiment is approximately equal to the area of the inner wall of the first communicating hole 244 according to the first embodiment. More precisely, the area of the inner wall of the first communicating hole 244 according to the second embodiment is larger than the area of the inner wail of the first communicating hole 244 according to the first embodiment by the area of the first heat conductor 245 provided on the upper face F1 and the lower face F2 of the upper plate 22.

Similarly, the opening area of the second communicating hole 262 defined by the second heat conductor 264 is equal to the opening area of the second communicating hole 262 according to the first embodiment. Accordingly, the area of the inner wall of the second communicating hole 262 according to the second embodiment is approximately equal to the area of the inner wall of the second communicating hole 262 according to the first embodiment. More precisely, the area of the inner wall of the second communicating hole 262 according to the second embodiment is larger than the area of the inner wall of the second communicating hole 262 according to the first embodiment by the area of the second heat conductor 264 provided on the upper face F1 and the lower face F2 of the upper plate 22.

The first heat conductor 245 and the second heat conductor 264 are made of a material having a higher thermal conductivity than the thermal conductivity of the material of the upper plate 22. According to this embodiment, an aluminum (Al) alloy having a higher thermal conductivity than the thermal conductivity of the material of the upper plate 22 is employed as the material of the first heat conductor 245 and the second heat conductor 264. The material used to form the first heat conductor and the second heat conductor is, however, not limited to this embodiment but may be another metal, such as copper (Cu), gold (Au) or silver (Ag). The first heat conductor 245 and the second heat conductor 264 may be formed, for example, by plating the surfaces of the first communicating holes 244 and the second communicating holes 262.

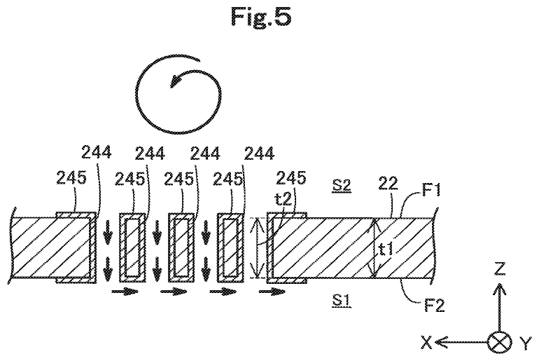

FIG. 5 is an enlarged sectional view illustrating the periphery of the first communicating boles 244 according to the second embodiment. FIG. 5 illustrates a portion corresponding to that of FIG. 3, and an arrow indicates a combustion wave like FIG. 3. According to the second embodiment, the combustion wave generated in the second space S2 comes into contact with the first heat conductor 245 when the combustion wave passes through the first communicating holes 244. The first heat conductor 245 is made of the material (Al alloy) having the higher thermal conductivity than the thermal conductivity of the material (Al alloy) used to form the upper plate 22 and is provided over the inner surfaces of the first communicating holes 244. Accordingly this configuration of the second embodiment, removes a larger amount of heat than the configuration of the first embodiment when the combustion wave generated in the second space S2 passes through the first communicating holes 244. As a result, this configuration further decreases the combustion rate of the combustion wave when passing through the first communicating holes 244, compared with the configuration of the first embodiment, and then causes the combustion wave of the decreased combustion rate to enter the first space

Similarly the configuration of the second embodiment removes a larger amount of heat than the configuration of the first embodiment when the combustion wave passes through the second communicating holes 262. Accordingly the configuration of the second embodiment further improves the safety of the fuel cell module, compared with the configuration of the first embodiment.

### C. Third Embodiment

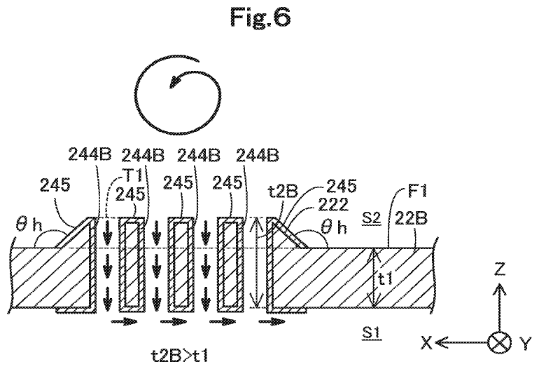

FIG. 6 is an enlarged sectional view illustrating the periphery of first communicating holes 244B according to a third embodiment. The configuration of the fuel cell module of the third embodiment is similar to the configuration of the fuel cell module of the second embodiment except the shape of the first communicating holes 244B. The following thus mainly describes the first communicating holes 244B. The like components to those of the fuel cell module of the second embodiment are expressed by the like reference signs, and their description is omitted.

According to this embodiment, a depth t2B of the first communicating holes 244B is greater than a plate thickness t1 of an upper plate 22B. More specifically, a protrusion 222 is provided on an upper face F1 of the upper plate 22B such as to surround the first communicating hole 244B and form part of the inner wall of the first communicating hole 244B. As a result, an opening end T1 (shown by a broken line in FIG. 6) of the first communicating hole 244B is protruded from the upper face F1 of the upper plate 22B toward the second space S2-side. The opening end T1 on the second space S2-side of the first communicating hole 244B and the upper face F1 of the upper plate 22B are connected with each other by an inclined plane that is an outer surface of the protrusion 222, and its connection angle θh is approximately 150 degrees according to this embodiment. The numerical value of the connection angle θh is, however, not limited to the numerical value of this embodiment but may be set to another adequate obtuse angle, for example, 170 degrees, 160 degrees or 135 degrees.

In the fuel cell module of this embodiment, the depth t2B of the first communicating holes 244B is greater than the plate thickness t1 of the upper plate 22B. Accordingly the configuration of the third embodiment provides the larger area of the wall surface which the combustion wave comes into contact with when the combustion wave generated in the second space S2 passes through the first communicating holes 244B, compared with the configuration of the second embodiment and thereby removes a larger amount of heat from the combustion wave compared with the configuration of the second embodiment. As a result, this configuration further decreases the combustion rate of the combustion wave generated in the second space S2, compared with the configuration of the second embodiment and then causes the combustion wave of the decreased combustion rate to enter the first space S1. The plate thickness t1 of the upper plate 22B is equal to the plate thickness t1 of the upper plate 22 according to the second embodiment. The configuration of the third embodiment thus suppresses an increase in weight of the module case compared with the module case of the second embodiment and causes the combustion wave generated in the second space S2 to be led into the first space S1 with further decreasing the combustion rate of the combustion wave.

### D. Fourth Embodiment

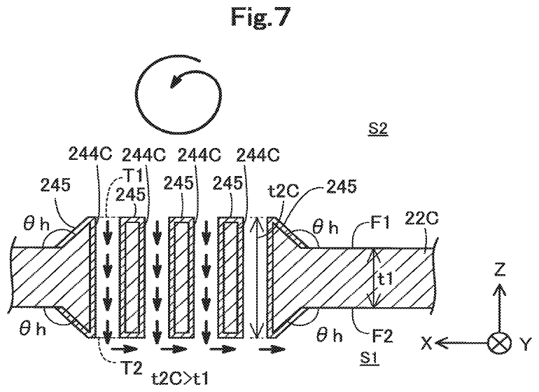

FIG. 7 is an enlarged sectional view illustrating the periphery of first communicating holes 2440 according to a fourth embodiment. The configuration of the fuel cell module of the fourth embodiment is similar to the configuration of the fuel cell module of the third embodiment except the shape of the first communicating holes 2440. The following thus mainly describes the first communicating holes 2440. The like components to those of the fuel cell module of the third embodiment are expressed by the like reference signs, and their description is omitted.

According to this embodiment, a depth t2C of the first communicating holes 2440 is greater than a plate thickness t1 of the upper plate 22C. The depth t2C of the first communicating holes 2440 is also deeper (greater) than the depth t2B of the first communicating holes 244B of the third embodiment. A protrusion is provided on an upper face F1 of the upper plate 220 such as to surround the communicating hole 244C and form part of the inner wall of the communicating hole 244C. A protrusion is also provided on a lower face F2 of the upper plate 220 such as to surround the communicating hole 244C and form part of the inner wall of the communicating hole 244C. As a result, an opening end Ti (shown by a broken line in FIG. 7) on the second space S2-side (upper side) of the first communicating hole 2440 is protruded from the upper face F1 of the upper plate 220 toward the second space S2-side (upper side). An opening end T2 (shown by a broken line in FIG. 7) on the first space S1-side (lower side) of the first communicating hole 244C is protruded from the lower face F2 of the upper plate 22C toward the first space S1-side (lower side).

The opening end T1 on the second space S2-side of the first communicating hole 244C and the upper face F1 of the upper plate 22C are connected with each other by an inclined plane that is an outer surface of the protrusion, and its connection angle θh is approximately 150 degrees according to this embodiment. Similarly the opening end T2 on the first space S1-side of the first communicating hole 244C and the lower face F2 of the upper plate 22C are connected with each other by an inclined plane, and its connection angle θh is approximately 150 degrees according to this embodiment. The numerical value of the connection angle θh is, however, not limited to the numerical value of this embodiment but may be set to another adequate obtuse angle, for example, 170 degrees, 160 degrees or 135 degrees. The connection angle on the second space S2-side may be different from the connection angle on the first space S1-side.

In the fuel cell module of this embodiment, the depth t2C of the first communicating hole 244C is further greater than that of the third embodiment. Accordingly the configuration of the fourth embodiment provides the larger area of the wall surface which the combustion wave comes into contact with when the combustion wave generated in the second space S2 passes through the first communicating holes 244C, compared with the configuration of the third embodiment and thereby removes a larger amount of heat from the combustion wave compared with the configuration of the third embodiment. As a result, this configuration further decreases the combustion rate of the combustion wave generated in the second space S2 and then causes the combustion wave of the decreased combustion rate to enter the first space S1. The respective opening ends of the first communicating hole 244C are protruded respectively from the upper face F1 and the lower face F2 of the upper plate 22C. This configuration shortens the length of the protrusion toward the first space S1 or toward the second space S2, compared with a configuration that a communicating hole of the same depth is formed by protruding its opening end from only one face of the upper plate 22C. In general, when a combustion wave is generated, large irregularity of a space in which the combustion wave is generated is likely to cause a turbulence and increase the combustion rate. The configuration of the this embodiment increases the length of the first communicating hole 244C compared with the configuration of the third embodiment, but elongates the first communicating hole 244C toward the first space SI-side instead of elongating toward the second space S2-side. This configuration accordingly suppresses an increase of the combustion rate in the second space S2. The configuration of this embodiment also reduces the amount of protrusion (length) of the first communicating hole 244C toward the first space S1 and the amount of protrusion (length) of the first communicating hole 244C toward the second space S2. This configuration accordingly ensures the depth of the first communicating hole 244C, while reducing the influence on the layout of the fuel cell 10 and the FCPC 30.

### E. Fifth Embodiment

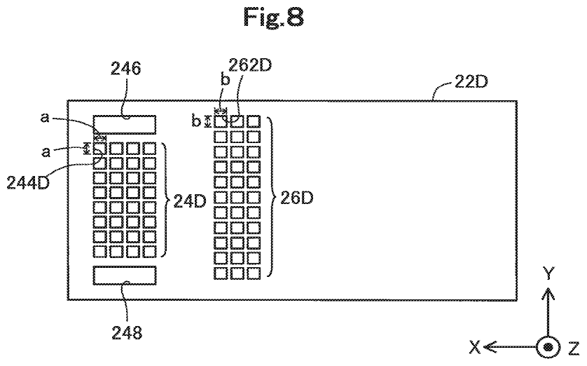

FIG. 8 is a schematic plan view illustrating an upper plate 22D of a fuel cell module according to a fifth embodiment. The configuration of the fuel cell module of the fifth embodiment is similar to the configuration of the fuel cell module 100 of the first embodiment, except the upper plate 22D. The following thus mainly describes the upper plate 22D. The like components to those of the fuel cell module 100 of the first embodiment are expressed by the like reference signs, and their description is omitted.

The upper plate 22D of this embodiment includes a first hole portion 24D and a second hole portion 26D, in place of the first hole portion 24 and the second hole portion 26 provided in the upper plate 22 of the first embodiment. The first hole portion 24D has thirty-two first communicating holes 244D that are arrayed in 8 lines×4 columns. The first communicating hole 244D has a square opening shape having a length a on each side. The length a is shorter than the width c of a gap between the fuel cell 10 and the upper plate 22D (as shown in FIG. 1). This length a is equal to the length a of the short side of the first communicating hole 244 according to the first embodiment.

The second hole portion 26D has thirty-three second communicating holes 2621) that are arrayed in 11 lines×3 columns. The second communicating hole 262D has a square opening shape having a length b on each side. The length b is shorter than the width c of the gap between the fuel cell 10 and the upper plate 22D (as shown in FIG. 1). According to this embodiment, the length a is equal to the length b. The length a and the length b may, however, be different from each other. In the description hereof, the term “square” may include a slight distortion or the like caused, for example, during manufacture.

The fuel cell module of this embodiment includes a large number of the first communicating holes 244D and a large number of the second communicating holes 262D in the square opening shapes respectively having the lengths on each side that are shorter than the width c of the gap between the fuel cell 10 and the upper plate 22D (as shown in FIG. 1). Accordingly the configuration of the fifth embodiment provides the larger area of the wall surface which the combustion wave comes into contact with when the combustion wave generated in the second space S2 passes through the first communicating holes 244D and the second communicating holes 262D, compared with the configuration of the first embodiment and thereby removes a larger amount of heat from the combustion wave compared with the configuration of the first embodiment. This configuration also improves the rectifying effect by the first communicating holes 244D and the second communicating holes 262D, compared with the configuration of the first embodiment. As a result, this configuration further decreases the combustion rate of the combustion wave generated in the second space S2 and then causes the combustion wave of the decreased combustion rate to enter the first space S1.

### E Sixth Embodiment

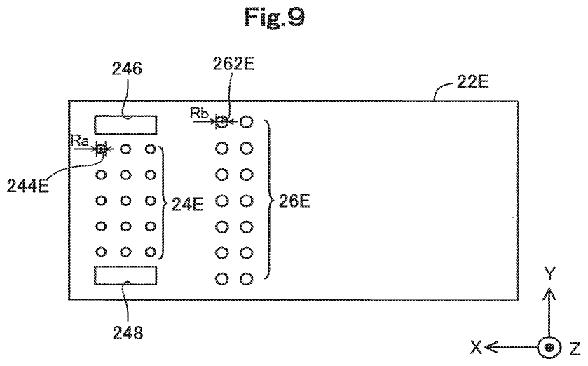

FIG. 9 is a schematic plan view illustrating an upper plate 22E of a fuel cell module according to a sixth embodiment. The configuration of the fuel cell module of the sixth embodiment is similar to the configuration of the fuel cell module 100 of the first embodiment, except the upper plate 22E. The following thus mainly describes the upper plate 22E. The like components to those of the fuel cell module 100 of the first embodiment are expressed by the like reference signs, and their description is omitted.

The upper plate 22E of this embodiment includes a first hole portion 24E and a second hole portion 26E, in place of the first hole portion 24 and the second hole portion 26 provided in the upper plate 22 of the first embodiment. The first hole portion 24E has fifteen first communicating holes 244E that are arrayed in 5 lines×3 columns. The first communicating hole 244E has a true circular opening shape having a diameter of Ra. The length iRa is shorter than the width c of a gap between the fuel cell 10 and the upper plate 22E (as shown in FIG. 1). The length Ra is equal to the length a of the short side of the first communicating hole 244 according to the first embodiment In the description hereof, the term “true circular shape” may include a slight distortion or the like caused, for example, during manufacture.

The second hole portion 26E has fourteen second communicating holes 262E that are arrayed in 7 lines×2 columns. The second hole portion 26E has a true circular opening shape having a diameter of Rb. The length Rb is shorter than the width c of the gap between the fuel cell 10 and the upper plate 22E (as shown in FIG. 1). The length Rb is longer than the length iRa. The length Ra and the length Rb are different from each other according to this embodiment, but may be identical with each other.

The fuel cell module of this embodiment includes a large number of the first communicating holes 244E and a large number of the second communicating holes 262E in the true circular opening shapes respectively having the diameters that are shorter than the width c of the gap between the fuel cell 10 and the upper plate 22D (as shown in FIG. 1). Like the fifth embodiment, the fuel cell module of this embodiment accordingly further decreases the combustion rate of the combustion wave generated in the second space S2 and then causes the combustion wave of the decreased combustion rate to enter the first space S1.

### G. Seventh Embodiment

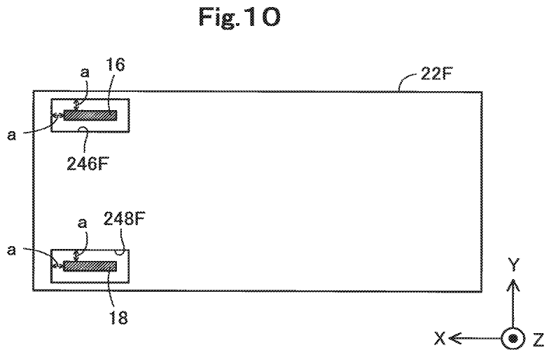

FIG. 10 is a schematic plan view illustrating an upper plate 22E of a fuel cell module according to a seventh embodiment. The configuration of the fuel cell module of the seventh embodiment is similar to the configuration of the fuel cell module 100 of the first embodiment, except the upper plate 22F. The following thus mainly describes the upper plate 22F. The like components to those of the fuel cell module 100 of the first embodiment are expressed by the like reference signs, and their description is omitted.

The upper plate 22F of this embodiment includes neither of the first hole portion 24 and the second hole portion 26 that are provided in the upper plate 22 of the first embodiment. In the upper plate 22F of this embodiment, the width of a gap between a first terminal communicating hole 246F and the first output terminal 16 is a length a. Similarly the width of gap between a second terminal communicating hole 248F and the second output terminal 18 is the length a. The length a is equal to the length a of the short side of the first communicating hole 244 according to the first embodiment. The first output terminal 16 of the fuel cell 10 is placed to pass through the first terminal communicating hole 246F, and the second output terminal 18 of the fuel cell 10 is placed to pass through the second terminal communicating hole 248F, so that communicating holes in a frame-like shape having the length a as the width are formed. The length a is shorter than the width c of a gap between the fuel cell 10 and the upper plate 22F (as shown in FIG. 1). The configuration shown in FIG. 10 also decreases the combustion rate of the combustion wave generated in the second space 82 and then causes the combustion wave of the decreased combustion rate to enter the first space S1.

### H. Eighth Embodiment

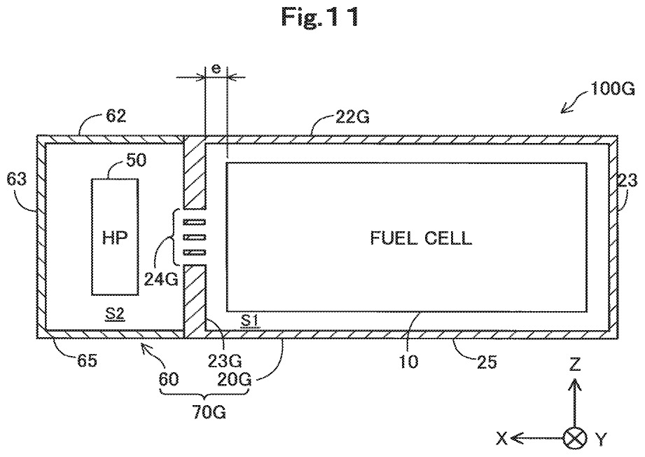

FIG. 11 is a diagram illustrating the schematic configuration of a fuel cell module 100G according to an eighth embodiment. Like FIG. 1, FIG. 11 illustrates a schematic section by an XZ plane of the fuel cell module 100G. In the description hereof, an X-axis direction shown in FIG. 11 is defined as “left-right direction”. A+(plus) X-axis side is also called “left side”, and a −(minus) X-axis side is also called “right side”. The fuel cell module 1006 includes a fuel cell 10, a hydrogen pump 50 and a module case 70G. The fuel cell 10 and the hydrogen pump 50 are fastened to the module case 70G. Illustration of fixtures is omitted in FIG. 11, in order to facilitate technical understanding. In the fuel cell module 100G of this embodiment, the configuration of the fuel cell 10 is similar to that of the first embodiment, and its description is accordingly omitted.

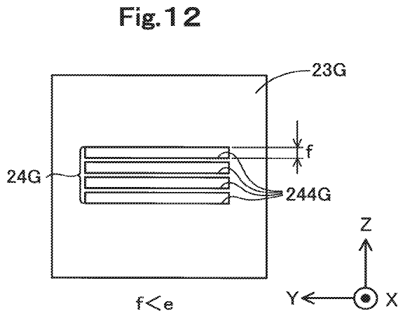

The hydrogen pump 50 is connected with the fuel cell 10 via a piping (not shown) and is also connected with a secondary battery (not shown) via a pump inverter (not shown). The hydrogen pump 50 is driven with supply of AC power from the pump inverter, such as to supply hydrogen included in an anode off-gas that is discharged from the fuel cell 10, to the fuel cell 10. The piping provided to connect the hydrogen pump 50 with the fuel cell 10 and a through hole formed to cause the piping to pass through are omitted from the illustrations of FIG. 11 and FIG. 12 described later, in order to facilitate technical understanding.

The module case 70G is provided as a case configured to place the fuel cell 10 and the hydrogen pump 50 therein and includes a fuel cell case 20G and a hydrogen pump case 60. The hydrogen pump case 60 is located on the left side (plus X-axis side) of the fuel cell case 20G. In other words, the hydrogen pump case 60 is placed to adjoin to a side face of the fuel cell case 20G.

The hydrogen pump case 60 is provided as a right-open housing that includes an upper plate 62, three side plates 63 and a lower plate 65. The hydrogen pump case 60 is fixed to the fuel cell case 20G such that its opening is closed by a left side face of the fuel cell case 20G. This provides a second space S2 to place the hydrogen pump 50 therein. According to this embodiment, the hydrogen pump 50 is fixed to the side plate 63 of the hydrogen pump case 60 by means of a support member (not shown). The hydrogen pump 50 is placed and fastened in the hydrogen pump case 60 and the hydrogen pump case 60 is fixed to the fuel cell case 20G, so that a gap is formed between the hydrogen pump 50 and the fuel cell case 20G.

The fuel cell case 20G is provided as a rectangular parallelepiped housing that includes an upper plate 22G, four side plates (three side plates 23 and one first side plate 23G) and a lower plate 25 and forms a first space Si to place the fuel cell 10 therein. According to this embodiment, one of the four side plates that forms a side face adjoining to the hydrogen pump case 60 and that includes a first hole portion 24G is called “first side plate 23G”.

FIG. 12 is a schematic front view illustrating the first side plate 23G. The schematic front view of FIG. 12 illustrates the first side plate 23G viewed from the second space S2-side (shown in FIG. 11). The first side plate 23G has a first hole portion 24G including four first communicating holes 244G. As shown in FIG. 11, the first space S1 in which the fuel cell 10 is placed and the second space S2 in which the hydrogen pump 50 is placed are arranged to adjoin to each other via the first side plate 23G in the module case 70G. The first communicating holes 244G provided in the first side plate 23G cause the first space S1 and the second space S2 to communicate with each other. The gas present in the first space Si and the gas present in the second space S2 mutually move in and out through the plurality of such communicating holes. The first side plate 23G according to this embodiment is also called “partition plate”.

The first hole portion 24G is placed on an approximate center of a plate surface (YZ plane) of the first side plate 23G and is provided at a position corresponding to the hydrogen pump 50. The first communicating holes 244G are slits (in a rectangular opening shape in which its short side is extremely shorter than its long side) (as shown in FIG. 12). A length f of the short side of the first communicating hole 244G is shorter than a width e of a gap between the fuel cell 10 and the first side plate 23G (as shown in FIG. 11). The four first communicating holes 244G are arrayed such that the long sides of the respective first communicating holes 244G are parallel to the lower plate 25 (parallel to the Y axis) and adjoin to each other. According to this embodiment, the length f of the short side is approximately 0.5 to 1.5 mm, and the width e of the gap between the fuel cell 10 and the first side plate 23G is approximately 2.0 to 3.0 mm. Like the first embodiment, when the fuel cell module 100E is mounted on a vehicle, the width e of the gap between the fuel cell 10 and the first side plate 23G is determined such that the fuel cell 10 does not hit against the first side plate 23G by vibration during driving of the vehicle and that the fuel cell 10 is not broken even in the case of a collision of the vehicle.

In assembly of the fuel cell module 100G, for example, the hydrogen pump case 60 in which the hydrogen pump 50 is placed is located on the first side plate 23G-side of the fuel cell case 20G in which the fuel cell 10 is placed, the piping is connected with the hydrogen pump 50, and the hydrogen pump case 60 is then fixed to the first side plate 23G of the fuel cell case 20G.

As described above, hydrogen as the fuel gas is supplied to the fuel cell 10. When hydrogen is leaked from a connection between the piping and the fuel cell 10 or from the fuel cell 10, part of the leaked hydrogen flows mainly through the first hole portion 24G into the second space S2. The fuel cell module 100G of this embodiment includes the first hole portion. 24G. Even when hydrogen is leaked from, for example, the fuel cell 10, this configuration prevents the hydrogen concentration in the first space S1 from being increased by the leaked hydrogen.

The hydrogen pump 50 is connected with the pump inverter via a cable. When hydrogen is present in the second space S2, the hydrogen is likely to be ignited in the second space S2. Even in the case of ignition that generates a combustion wave in the second space S2, the fuel cell module 100G of this embodiment causes the combustion wave generated in the second space S2 to be subjected to heat removal and to be rectified by the inner wall surfaces of the first communicating holes 244G when passing through the first communicating holes 244G and then to enter the first space S1. As a result, this configuration decreases the combustion rate (i.e., weakens the combustion wave) or quenches the combustion wave (i.e., stops combustion). The depth of the first communicating hole 244G according to this embodiment is equal to the plate thickness of the first side plate 23G (as shown in FIG. 11). According to this embodiment, the length f of the short side of the first communicating hole 244G is shorter than the width e of the gap between the fuel cell 10 and the first side plate 23G. The combustion wave is rectified to have the decreased combustion rate when passing through the first communicating holes 244G, and then enters the gap between the fuel cell 10 and the first side plate 23G with practically maintaining this state. As a result, this configuration suppresses an increase in combustion rate of the combustion wave that flows into the gap. For example, a configuration that the length f of the short side of the first communicating hole 244G is longer than the width e of the gap between the fuel cell 10 and the first side plate 23G is, on the other hand, expected to provide the following situation. The combustion wave increases its pressure when entering the gap between the fuel cell 10 and the first side plate 23G. This increases the reaction rate to increase the heat generation rate and increases the combustion rate. In the fuel cell module 100G of this embodiment, the first side plate 23G of the module case 70G includes the first communicating holes 244G, and the length f of the short side of the first communicating hole 244G is shorter than the width e of the gap between the fuel cell 10 and the first side plate 23G. Even in the case of ignition of the leaked hydrogen in the hydrogen pump case 60 (second space S2), the configuration of this embodiment suppresses an increase in combustion rate when the combustion wave enters the gap between the fuel cell 10 and the first side plate 23G. As a result, this configuration suppresses the fuel cell case 20G from being broken by the combustion wave and improves the safety of the fuel cell module 100G.

### I. Modifications

(1) The above embodiments illustrate the FCPC 30 and the hydrogen pump 50 as the fuel cell auxiliary machines placed in the module case 70. The fuel cell auxiliary machine is, however, not limited to these embodiments, but another fuel cell auxiliary machine, for example, an air compressor or a cooling water pump may be placed in the module case 70.

(2) In the first embodiment described above, the fuel cell case 20 includes the upper plate 22 serving as the partition plate. In the eighth embodiment described above, the fuel cell case 20G includes the first side plate 23G serving as the partition plate. According to a modification, however, a fuel cell auxiliary machine case such as the FCPC case 40 or the hydrogen pump case 60 may be configured to include a partition plate.

(3) The above embodiments illustrate the slits, the square opening shape and the true circular opening shape as the shape of the communicating hole provided to connect the first space Si and the second space S2. The shape of the communicating hole or the connecting hole provided to connect the first space S1 and the second space S2 is, however, not limited to these embodiments. According to a modification, the communicating hole may be a through hole in an opening shape having a side or a diameter that is smaller than the width of the gap between the fuel cell and the partition plate. For example, the opening shape of the communicating hole may be a rectangular shape, an elliptical shape or a corner-rounded quadrangular shape. In the case of the communicating hole in the rectangular opening shape, the length of the short side is set to be smaller than the width of the gap between the fuel cell and the partition plate. In the case of the communicating hole in the elliptical opening shape, the minor axis is set to be smaller than the width of the gap between the fuel cell and the partition plate. Such configuration provides the similar advantageous effects to those of the above embodiment. In the description hereof, the “diameter” of the opening shape that is to be compared with the width of the gap between the fuel cell and the partition plate means the length of a shortest line segment among line segments that start and terminate on the outer circumference of the opening shape and pass through the center of gravity of the opening shape irrespective of the opening shape.

(4) The above embodiments illustrate the partition plate having a plurality of communicating holes that cause the first space S1 and the second space S2 to communicate with each other. The partition plate may have at least one communicating hole that causes the first space S1 and the second space S2 to communicate with each other (the opening shape of the communicating hole has a side or a diameter that is smaller than the width of the gap between the fuel cell and the partition plate).

(5) The width (short side) or the diameter (minor axis) of the communicating hole that causes the first space S1 and the second space S2 to communicate with each other is not limited to the above embodiments but may be any length that is smaller than the width of the gap between the fuel cell and the partition plate. It is preferable to set the width (short side) or the diameter (minor axis) of the communicating hole to be equal to or shorter than the quenching distance, since this is more likely to quench the combustion wave generated in the second space S2 when the combustion wave passes through the communicating hole.

(6) The above first embodiment describes the configuration that the length a of the short side of the first communicating hole 244 is equal to the length b of the short side of the second communicating hole 262 (a=b). According to a modification, however, the length a of the short side of the first communicating hole 244 may be different from the length b of the short side of the second communicating hole 262. When the length a of the short side of the first communicating hole 244 is different from the length b of the short side of the second communicating hole 262, it is preferable that one of the length a and the length b is shorter than the width c of the gap between the fuel cell 10 and the upper plate 22 (shown in FIG. 1). It is more preferable that both the length a of the short side of the first communicating hole 244 and the length b of the short side of the second communicating hole 262 are shorter than the width c of the gap between the fuel cell 10 and the upper plate 22 (shown in FIG. 1).

(7) The above first embodiment describes the configuration that the FCPC case 40 includes the hydrogen permeable membrane 422. According to a modification, however, the FCPC case 40 may not include the hydrogen permeable membrane 422. According to another modification, the FCPC case 40 may include a bleeder valve, in place of the hydrogen permeable membrane 422.

(8) The above embodiments illustrate the configuration that the FCPC 30 is placed on the fuel cell 10 (as shown in FIG. 1) and the configuration that the hydrogen pump 50 is placed on the left side of the fuel cell 10 (as shown in FIG. 11). The arrangement of the fuel cell 10 and the fuel cell auxiliary machine is, however, not limited to the above embodiments. In other words, the arrangement of the first space in which the fuel cell is placed and the second space in which the fuel cell auxiliary machine is placed is not limited to the above embodiments in the module case configured to place the fuel cell and the fuel cell auxiliary machine therein, the first space in which the fuel cell is placed and the second space in which the fuel cell auxiliary machine is placed are to be arranged to adjoin to each other via the partition plate. For example, the FCPC 30 may be placed below the fuel cell 10. In another example, the FCPC 30 and the fuel cell 10 may be arranged side by side (on the XY plane).

(9) The above second embodiment illustrates the configuration that the first heat conductor 245 is provided on the respective inner walls of the four first communicating holes 244 and the peripheries of the opening ends of the respective communicating holes 244 (upper face F1 and lower face F2 of the upper plate 22) (as shown in FIG. 5). According to a modification, the first heat conductor 245 may be provided on at least part of the inner wall of at least one first communicating hole 244. The same applies to the second heat conductor 264. A heat conductor that is made of a material having a higher thermal conductivity than the thermal conductivity of the material used to form the upper plate 22 may be provided on the inner walls of at least one of the first communicating holes 244 and the second communicating holes 262.

The disclosure is not limited to any of the embodiments, the examples and the modifications described above but may be implemented by a diversity of other configurations without departing from the scope of the disclosure. For example, the technical features of any of the embodiments, the examples and the modifications may be replaced or combined appropriately, in order to solve part or all of the problems described above or in order to achieve part or all of the advantageous effects described above. Any of the technical features may be omitted appropriately unless the technical feature is described as essential in the description hereof. For example, the present disclosure may be implemented by any of the aspects described below.

(1) According to one aspect of the disclosure, there is provided a fuel cell module. The fuel cell module has: a fuel cell; a fuel cell auxiliary machine; and a module case configured to place the fuel cell and the fuel cell auxiliary machine therein. The module case has a partition plate, a first space in which the fuel cell is placed and a second space in which the fuel cell auxiliary machine is placed. The first space and the second space adjoin to each other via the partition plate. The partition plate has a communicating hole that connects the first space and the second space and that is formed in an opening shape having a side or a diameter that is smaller than a width of a gap between the fuel cell and the partition plate. In the fuel cell module of this aspect, the partition plate of the module case includes the communicating hole. When a combustion wave is generated in the second space, the combustion wave propagates through the communicating hole into the first space. The combustion wave generated in the second space comes into contact with the wall surface of the communicating hole such as to be subjected to heat removal and to be rectified when the combustion wave passes through the communicating hole. This accordingly decreases the combustion rate (i.e., weakens the combustion wave) or quenches the combustion wave (i.e., stops combustion). This configuration thus suppresses a pressure increase accompanied with combustion in the first space in which the fuel cell is placed, and suppresses the module case from being broken. The opening shape of the communicating hole has a side or a diameter that is smaller than the width of the gap between the fuel cell and the partition plate. This configuration enables the combustion wave having the combustion rate decreased when passing through the communicating hole to pass through the gap between the fuel cell and the partition plate without increasing the combustion rate. This configuration accordingly suppresses an increase of the combustion rate in the first space and improves the safety of the fuel cell module.

(2) The fuel cell module of the above aspect may further comprise a heat conductor provided on at least part of an inner wall of the communicating hole and made of a material having a higher thermal conductivity than a thermal conductivity of a material used to form the partition plate. This configuration causes the combustion wave to come into contact with the heat conductor when the combustion wave generated in the second space passes through the communicating hole. This configuration accordingly allows for removal of a larger amount of heat, compared with a configuration that is not equipped with the heat conductor but has the same area of the inner wall of the communicating hole as that of this aspect, and thereby further decreases the combustion rate or quenches the combustion wave. This accordingly further improves the safety of the fuel cell module.

(3) In the fuel cell module of the above aspect, a protrusion, may be provided on at least one surface of the partition plate such as to surround the communicating hole and form part of an inner wall of the communicating hole. The communicating hole may have a depth that is greater than a plate thickness of the partition plate. The greater depth of the communicating hole provides the greater area of the wall surface which a combustion wave comes into contact with when the combustion wave generated in the second space passes through the communicating hole. This configuration allows for removal of a larger amount of heat and thereby further decreases the combustion rate. The configuration that the depth of the communicating hole is greater than the plate thickness of the partition plate allows the partition plate to be relatively thin and reduces the weight of the module case, while enabling the combustion wave generated in the second space to be lead into the first space with decreasing the combustion rate of the combustion wave.

1. A fuel cell module, comprising:
a fuel cell;
a fuel cell auxiliary machine; and
a module case configured to place the fuel cell and the fuel cell auxiliary machine therein, the module case comprising a partition plate, a first space in which the fuel cell is placed and a second space in which the fuel cell auxiliary machine is placed, wherein the first space and the second space adjoin to each other via the partition plate, wherein
the partition plate includes a communicating hole that connects the first space and the second space and that is formed in an opening shape having a side or a diameter that is smaller than a width of a gap between the fuel cell and the partition plate, wherein
the communicating hole faces the fuel cell.

2. The fuel cell module according to claim 1, further comprising:
a heat conductor provided on at least part of an inner wall of the communicating hole and made of a material having a higher thermal conductivity than a thermal conductivity of a material used to form the partition plate.

3. The fuel cell module according to claim 1,
wherein a protrusion is provided on at least one surface of the partition plate such as to surround the communicating hole and form part of an inner wall of the communicating hole, and
the communicating hole has a depth that is greater than a plate thickness of the partition plate.
